(19) United States
(12) Patent Application Publication
(10) Pub. No.: US 2025/0243692 A1
(43) Pub. Date: Jul. 31, 2025

(54) SMART PET DOOR

(71) Applicant: SHENZHEN ZHONGDUNLIANTOU TECHNOLOGY CO., LTD., SHENZHEN CITY (CN)

(72) Inventor: GUI HONG, HUNAN PROVINCE (CN)

(21) Appl. No.: 19/033,492

(22) Filed: Jan. 22, 2025

(30) Foreign Application Priority Data
Jan. 25, 2024 (CN) 202420185933.1

(51) Int. Cl. E05B 47/00; A01K 1/035; E06B 1/60; E06B 7/32

(52) U.S. Cl. CPC E05B 47/0012; A01K 1/035; E06B 1/60; E06B 7/32; E05B 2047/0017; E05B 2047/0058; E05B 2047/0067; E05B 2047/0094

(57) ABSTRACT

Disclosed is a smart pet door, including: a door frame, a door plate and a door lock. The door lock includes a motor, a front locking piece, a rear locking piece, a circuit main board and a power supply. The front and rear locking pieces are coaxially arranged and in transmission connection with the motor, the motor is electrically connected to the circuit main board, and the circuit main board is electrically connected to the power supply. The front locking piece is positioned on a front side of a lower edge of the door plate, the rear locking piece is positioned on a rear side of the lower edge of the door plate, and the motor drives the front and rear locking pieces to rotate. The front and rear locking pieces are able to abut against the door plate separately or simultaneously, or disengage from the door plate simultaneously.

### CROSS-REFERENCE TO RELATED PATENT APPLICATION

The present application claims the priority of Chinese Patent Application No. 202420185933.1, filed on Jan. 25, 2024, which is hereby incorporated by reference in its entirety.

### FIELD OF THE DISCLOSURE

The present application relates to the technical field of pet products, and in particular, to a smart pet door.

### BACKGROUND OF THE DISCLOSURE

At present, with the improvement of people's living standards, more and more families are keeping pets. To facilitate pets to enter and exit a room, most families directly provide a small door for the pets to enter and exit at a bottom part of a room door, thereby meeting the demands of pets to enter and exit freely.

In the prior art, a plurality of smart pet doors can be opened and closed remotely by a solenoid valve lock. Such door locks generally have two states of bidirectional opening or locking, so that a pet can enter and exit freely or cannot enter and exit. However, it is rather difficult for pet owners to control such door locks to allow pets to enter only or exit only at different times or in different scenarios, and it is difficult to meet the diverse needs of the pet owners.

### SUMMARY OF THE DISCLOSURE

In view of this, the present application provides a smart pet door, which is used to solve the problem that the door lock of the smart pet door in the prior art cannot achieve the control of the unidirectional or bidirectional opening and closing of the pet door.

To achieve one or part or all of the above objects or other objects, the present application provides: a smart pet door, including: a door frame, a door plate and a door lock, wherein the door plate is hinged to an upper frame of the door frame, and the door lock is mounted on a lower frame of the door frame;
the door lock includes a motor, a front locking piece, a rear locking piece, a circuit main board and a power supply, the front locking piece and the rear locking piece are coaxially arranged and in transmission connection with the motor, the motor is electrically connected to the circuit main board, and the circuit main board is electrically connected to the power supply;
the front locking piece is positioned on a front side of a lower edge of the door plate, the rear locking piece is positioned on a rear side of the lower edge of the door plate, and the motor drives the front locking piece and the rear locking piece to rotate, so that the door lock is in one of following four states;
when the door lock is in a first state, the front locking piece and the rear locking piece both block the door plate from being rotated and opened;
when the door lock is in a second state, the front locking piece and the rear locking piece both avoid the door plate, and the door plate can be rotated and opened bidirectionally;
when the door lock is in a third state, the front locking piece blocks the door plate, the rear locking piece avoids the door plate, and the door plate can be opened inward only; and
when the door lock is in a fourth state, the front locking piece avoids the door plate, the rear locking piece blocks the door plate, and the door plate can be opened outward only.

Preferably, the front locking piece and the rear locking piece are parallel to each other and are arranged at intervals on a rotating shaft of the motor, and a distance between the front locking piece and the rear locking piece is adapted to a thickness of the lower edge of the door plate.

Preferably, the front locking piece is in a right-angled sector shape, the rear locking piece is in a waist-like shape, and one right-angled edge of the front locking piece is parallel to two straight edges of the rear locking piece.

Preferably, a distance from an axis of the front locking piece to an arc-shaped edge thereof is greater than a height from the axis of the front locking piece to the lower edge of the door plate, and a distance from the axis of the front locking piece to any right-angle edge thereof is less than the height from the axis of the front locking piece to the lower edge of the door plate.

Preferably, a distance from an axis of the rear locking piece to any arc-shaped edge thereof is greater than a height from the axis of the rear locking piece to the lower edge of the door plate, and a distance from the axis of the rear locking piece to any straight edge thereof is less than the height from the axis of the rear locking piece to the lower edge of the door plate.

Preferably, the distance from the axis of the rear locking piece to any arc-shaped edge thereof is equal to the distance from the axis of the front locking piece to any arc-shaped edge thereof, and the distance from the axis of the rear locking piece to any straight edge thereof is equal to the distance from the axis of the front locking piece to any right-angle edge thereof.

Preferably, a tab protruding from a lower side of the door plate is provided on the lower edge of the door plate, the tab has a thinner thickness than that of the door plate, the front locking piece is positioned on a front side of the tab, and the rear locking piece is positioned on a rear side of the tab.

Preferably, the front locking piece and the rear locking piece are circumferentially and evenly divided into four regions, and wherein the door lock is in the first state when a first region is aligned with the lower edge of the door plate, the door lock is in the second state when a second region is aligned with the lower edge of the door plate, the door lock is in the third state when a third region is aligned with the lower edge of the door plate, and the door lock is in the fourth state when a fourth region is aligned with the lower edge of the door plate.

Preferably, a front side of the front locking piece is provided with a manual knob exposed out of the door frame, and the manual knob is configured to manually control the rotation of the door lock to change a state of the door lock.

Preferably, an identity identification module electrically connected to the circuit main board is provided on the door frame, the identity identification module is configured to verify an identity of a pet and send the identity information of the pet to the circuit main board after confirming the identity information of the pet, and the circuit main board controls the motor to change a state of the door lock.

Preferably, the door frame is provided with a sensing module electrically connected to the circuit main board, and the sensing module wakes up the circuit main board when sensing the approach of a pet; and wherein an identification distance of the identity identification module is 10-30 cm, and an identification distance of the sensing module is 80-220 cm.

Preferably, the upper frame of the door frame is provided with a battery compartment, and the power supply is provided within the battery compartment.

Preferably, a back side of the door frame is provided with a mounting frame, and the mounting frame is configured to clamp to a door opening.

Preferably, one side of the mounting frame far away from the door frame is detachably assembled with a rear frame, an outer frame of the rear frame is larger than that of the mounting frame, and after the door frame and the mounting frame are clamped to the door opening, and the rear frame is assembled with the mounting frame to secure the smart pet door.

After the technical solution is adopted, the present application has the beneficial effects that: the front locking piece and the rear locking piece are coaxially arranged to limit a front side and a rear side of the door plate, respectively; and the front locking piece and the rear locking piece are controlled to rotate by the motor, so that the front locking piece and the rear locking piece can flexibly limit the door plate. This achieves the function of controlling the door plate to unidirectionally open inward, unidirectionally open outward and bidirectionally open and close, and can meet the diverse needs of the pet owners.

### BRIEF DESCRIPTION OF THE DRAWINGS

To more clearly illustrate the technical solutions in the embodiments of the present application or in the prior art, the drawings required to be used in the description of the embodiments or the prior art are briefly introduced below. It is obvious that the drawings in the description below are some embodiments of the present application, and those of ordinary skill in the art can obtain other drawings according to the drawings provided herein without creative efforts.

FIG. 1 is a schematic diagram I of an overall structure according to a smart pet door;

FIG. 2 is a schematic diagram II of an overall structure according to a smart pet door;

FIG. 3 is a schematic diagram III of an overall structure according to a smart pet door;

FIG. 4 is a schematic diagram I of an exploded structure according to a smart pet door;

FIG. 5 is a schematic diagram II of an exploded structure according to a smart pet door;

FIG. 6 is a schematic diagram I of a front locking piece and a rear locking piece according to a smart pet door; and

FIG. 7 is a schematic diagram II of a front locking piece and a rear locking piece according to a smart pet door.

### LIST OF REFERENCE SIGNS

Reference numerals are as follows: 10: door frame; 11: manual knob; 12: function button; 13: sensing module; 14: radio frequency antenna; 15: battery compartment; 16: mounting frame; 161: sliding groove; 17: rear frame; 171: sliding block; 20: door plate; 21: tab; 30: door lock; 31: motor; 32: front locking piece; 33: rear locking piece; 34: circuit main board; and 35: power supply.

### DETAILED DESCRIPTION OF THE EXEMPLARY EMBODIMENTS

Unless otherwise defined, all technical and scientific terms used in the present application have same meanings as those usually understood by those skilled in the art of the present application. The terms used in the specification of the present application are merely for the purpose of describing specific embodiments, and are not intended to limit the present application. The terms “comprising”, “having”, or any other variant thereof in the descriptions of the specification, claims, and above accompanying drawings of the present application are intended to cover a non-exclusive inclusion. In the specification, claims, and above accompanying drawings of the present application, terms “first”, “second”, and the like are intended to distinguish between different objects but do not indicate a particular sequential.

An “embodiment” mentioned in the present application means that a particular characteristic, structure, or feature described with reference to embodiments may be included in at least one embodiment of the present application. The phrase shown in various locations in the specification may not necessarily refer to a same embodiment, and is not an independent or optional embodiment exclusive from another embodiment. It is explicitly and implicitly understood by those skilled in the art that embodiments described in the present application may be combined with another embodiment.

To enable those skilled in the art to better understand the solutions of the present application, the technical solutions in the embodiments of the present application are clearly and completely described below in conjunction with the drawings.

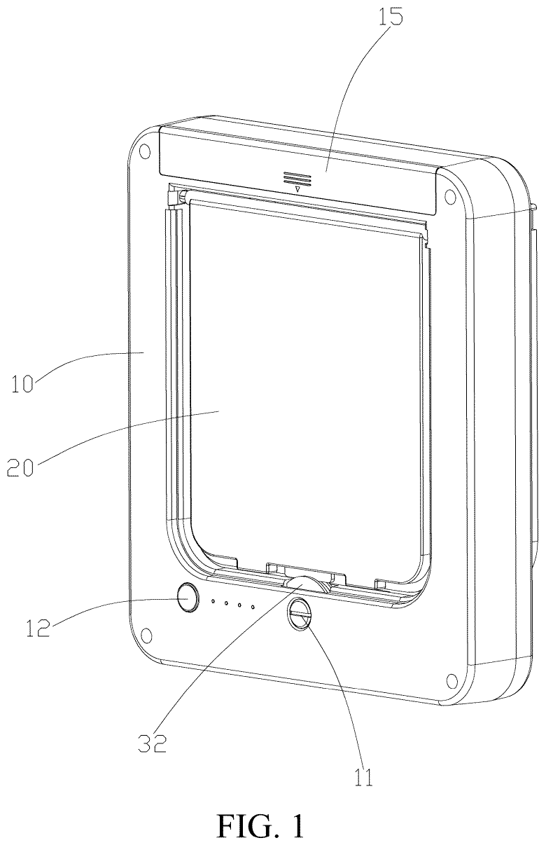

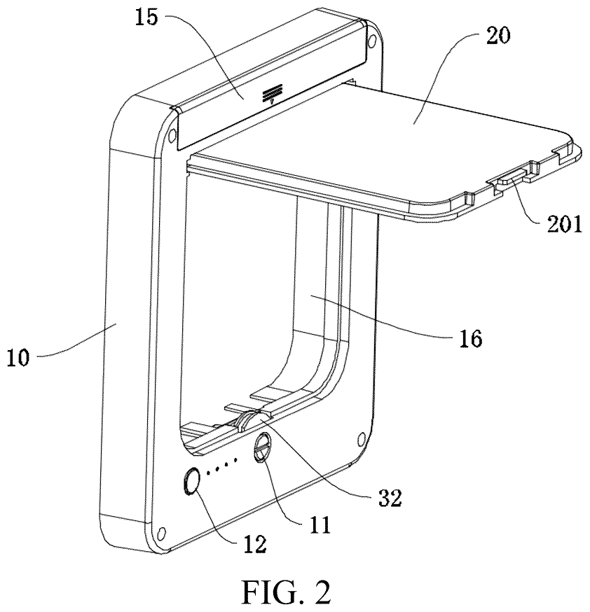

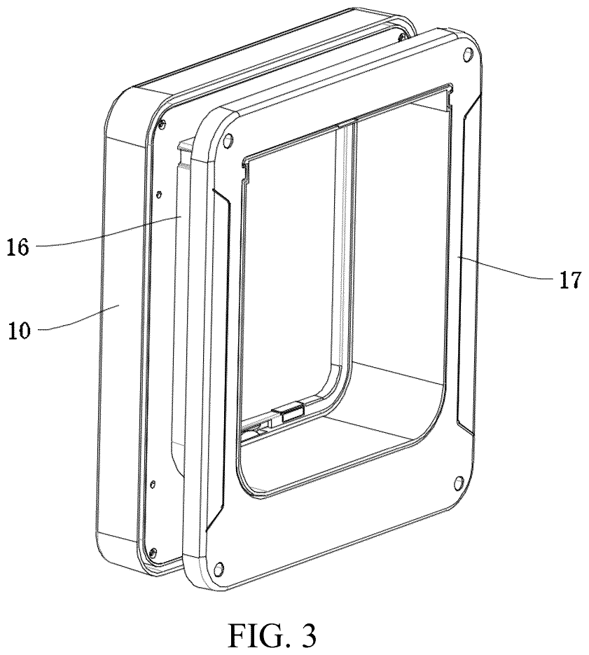

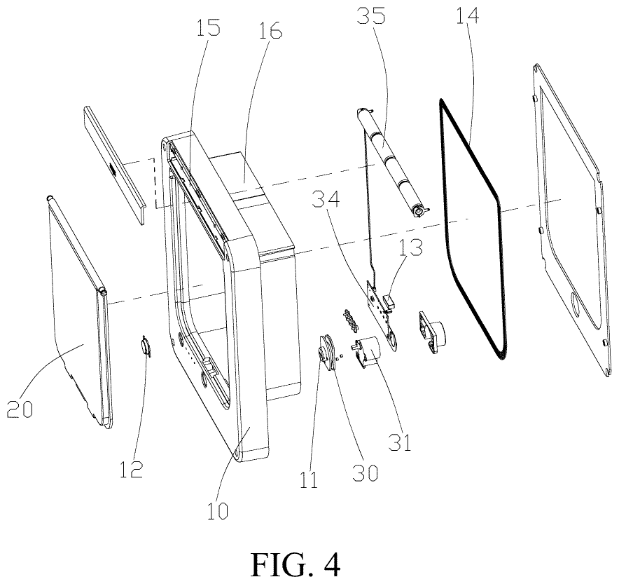

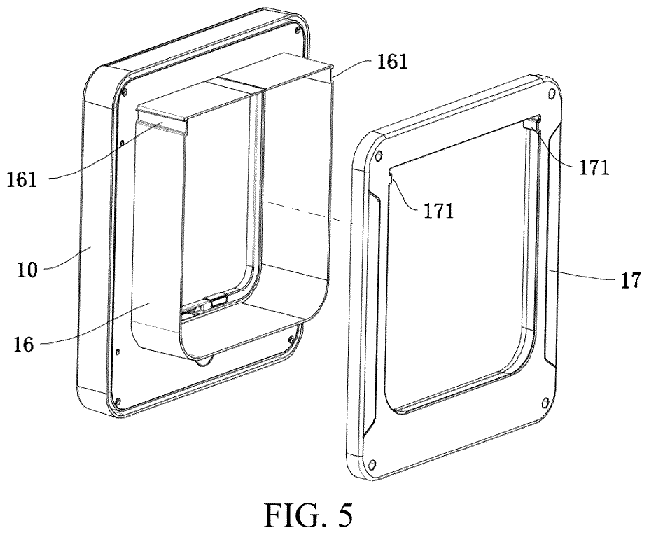

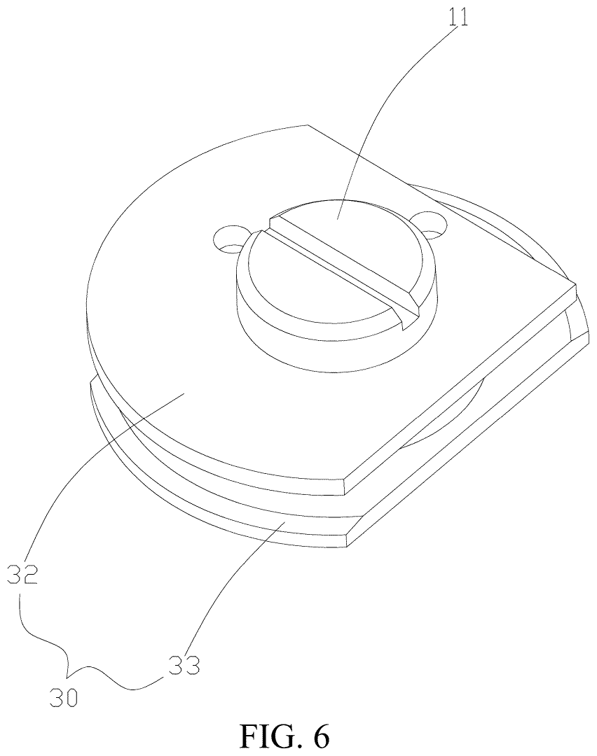

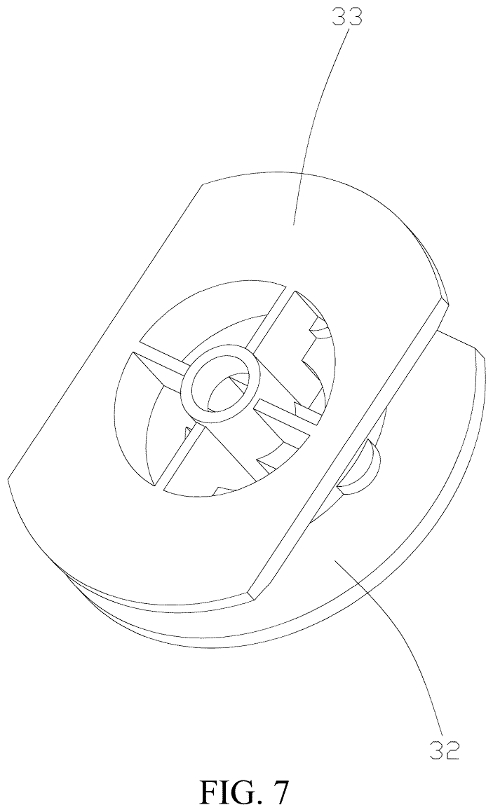

FIGS. 1-7 are embodiments of the present application.

The embodiments of the present application provide a smart pet door, which includes: a door frame 10, a door plate 20 and a door lock 30. A back side of the door frame 10 is provided with a mounting frame 16, and the mounting frame 16 is used to clamp to a door opening, so that the pet door is mounted on a room door. The door plate 20 is hinged to an upper frame of the door frame 10 by selectively arranging hinge shafts at two sides of an upper edge of the door plate 20, two sides of the door frame 10 are provided with hinge holes, and two ends of each hinge shaft are respectively inserted into the hinge holes at two sides of the door frame 10, so that the hinge of the door plate 20 to the door frame 10 may be achieved. The upper edge of the door plate 20 is hinged to the upper frame of the door frame 10, so that a lower part of the door plate 20 can freely swing inward and outward toward the door frame 10, which is convenient for pets to enter and exit. The door plate 20 eventually stays in a state perpendicular to the ground under the action of gravity, the door lock 30 is mounted on the lower frame of the door frame 10 and is opposite to the lower edge of the door plate 20, so that there is no need to manually adjust the position of the door plate 20 when locking the door, and the door plate 20 naturally aligns with the door lock 30. Specifically, the door lock 30 includes a motor 31, a front locking piece 32, a rear locking piece 33, a circuit main board 34 and a power supply 35. The circuit main board 34 is electrically connected to the power supply 35. The power supply 35 may be a battery, which is convenient for home use and replacement. A battery compartment 15 is provided on an outer side of the upper frame of the door frame 10, and the power supply 35 is arranged in the battery compartment 15, which is convenient for user operation. The motor 31 is electrically connected to the circuit main board 34, and the motor 31 may use the existing micro reduction motor 31 on the market. The circuit main board 34 may be a control circuit board available from the market, which can control the rotation of the motor 31. The front locking piece 32 and the rear locking piece 33 are coaxially arranged and are in transmission connection with the motor 31, and the motor 31 may drive the front locking piece 32 and the rear locking piece 33 to rotate simultaneously.

One side of the mounting frame 16 far away from the door frame 10 is detachably assembled with a rear frame 17, and an outer frame of the rear frame 17 is larger than that of the mounting frame 16. During mounting, after the door frame 10 and the mounting frame 16 are clamped to the door opening, the rear frame 17 is assembled onto the mounting frame 16 to fix the entire smart pet door. In one embodiment, inwardly recessed sliding grooves 161 are provided on a left outer side and a right outer side of the mounting frame 16 respectively, and outwardly protruding sliding blocks 171 are provided on a left outer side and a right outer side of the rear frame 17 respectively. When the rear frame 17 moves toward the mounting frame 16, the sliding blocks 171 are gradually placed into the sliding grooves 161 to assemble the rear frame 17 on the mounting frame 16. This structure does not require screws and is very easy to mount.

The front locking piece 32 is positioned on a front side of a lower edge of the door plate 20, the rear locking piece 33 is positioned on a rear side of the lower edge of the door plate 20, and the motor 31 drives the front locking piece 32 and the rear locking piece 33 to rotate, so that the door lock 30 is in one of following four states. When the door lock 30 is in a first state, the front locking piece 32 and the rear locking piece 33 both block the door plate 20 from being rotated and opened. When the door lock 30 is in a second state, the front locking piece 32 and the rear locking piece 33 both avoid the door plate 20, and the door plate 20 can be rotated and opened bidirectionally. when the door lock 30 is in a third state, the front locking piece 32 blocks the door plate 20, the rear locking piece 33 avoids the door plate, and the door plate 20 can be opened inward only. when the door lock 30 is in a fourth state, the front locking piece 32 avoids the door plate 20, the rear locking piece 33 blocks the door plate 20, and the door plate 20 can be opened outward only.

In some embodiments, the front locking piece 32 and/or the rear locking piece 33 are in an abutting relationship with the door plate 20 when in a state of blocking the door plate 20; that is, the front locking piece 32 and the rear locking piece 33 can abut against the door plate 20 separately, or abut against the door plate 20 simultaneously, or disengage from the door plate 20 simultaneously.

In other embodiments, the front locking piece 32 and the rear locking piece 33 have a gap with the door plate 20 when in a state of blocking the door plate 20.

When the front locking piece 32 blocks a front side of the door plate 20 alone, the door plate 20 can only be opened inward, and pets can only enter from the outside of the door and cannot exit from the inside of the door. When the rear locking piece 33 blocks a rear side of the door plate 20 alone, the door plate 20 can only be opened outward, and pets can only exit from the inside of the door and cannot enter from the outside of the door. When the front locking piece 32 and the rear locking piece 33 block the door plate 20 at the same time, the door plate 20 is locked, and the pets cannot enter or exit. When the front locking piece 32 and the rear locking piece 33 avoid the door plate 20 at the same time, the door plate 20 may be bidirectionally opened, and the pets can enter and exit freely. After the smart pet door is adopted, a pet owner may set the working state and the working time of the motor 31 by the circuit main board 34, so that the mode that a pet enters and exits a room can be flexibly changed, such as allowing the pet to only enter but not exit the room during a certain period of time, or only exit but not enter the room, to meet the various actual requirements in the common life of the pet owner and the pet.

Specifically, the front locking piece 32 and the rear locking piece 33 are parallel to each other and are arranged at intervals on a rotating shaft of the motor 31, and a distance between the front locking piece 32 and the rear locking piece 33 is adapted to a thickness of the lower edge of the door plate 20. Generally, the distance between the front locking piece 32 and the rear locking piece 33 is greater than or equal to the thickness of the lower edge of the door plate 20.

The front locking piece 32 and the rear locking piece 33 are circumferentially and evenly divided into four regions, and wherein the door lock 30 is in the first state when a first region is aligned with the lower edge of the door plate 20, the door lock 30 is in the second state when a second region is aligned with the lower edge of the door plate 20, the door lock 30 is in the third state when a third region is aligned with the lower edge of the door plate 20, and the door lock 30 is in the fourth state when a fourth region is aligned with the lower edge of the door plate 20.

Specifically, the front locking piece 32 is in a right-angled sector shape, an arc-shaped edge of the right-angled sector is an arc of a circle, and an intersection of the two right-angled edges is positioned on a circumference of the circle where the arc-shaped edge is positioned. The rear locking piece 33 is in a waist-like shape, two arc-shaped edges of the waist are arcs of the same circle, and the two right-angled edges of the waist are parallel lines symmetrical with a diameter of the circle as an axis. One right-angled edge of the front locking piece 32 is parallel to two straight-angled edges of the rear locking piece 33, and another right-angled edge of the front locking piece 32 is perpendicular to the two straight-angled edges of the rear locking piece 33. A distance from an axis of the front locking piece 32 to an arc-shaped edge thereof is greater than a height from the axis of the front locking piece 32 to the lower edge of the door plate 20, so that the front locking piece 32 can limit the door plate 20 and block the door plate 20 from being opened outward when rotating to a state where the right angle thereof is positioned downward. A distance from the axis of the front locking piece 32 to any right-angle edge thereof is less than the height from the axis of the front locking piece 32 to the lower edge of the door plate 20, so that the door plate 20 can be opened outward when the front locking piece 32 is rotated to a state where the right angle thereof is positioned upward. Meanwhile, a distance from an axis of the rear locking piece 33 to any arc-shaped edge thereof is greater than a height from the axis of the rear locking piece 33 to the lower edge of the door plate 20, so that the rear locking piece 33 can limit the door plate 20 and block the door plate 20 from opening inward when rotating to a vertical state. A distance from the axis of the rear locking piece 33 to any straight edge thereof is less than the height from the axis of the rear locking piece 33 to the lower edge of the door plate 20, so that the lower edge of the door plate 20 cannot be blocked when the rear locking piece 33 rotates to a horizontal state, and the door plate 20 can be opened inward. In this embodiment, the right angle of the front locking piece 32 may be selectively positioned at the upper left, and the position of the rear locking piece 33 in a transverse state is set as an initial position; in this case, the door plate 20 is in the state of being able to be opened both inward and outward. When the rotating shaft of the motor 31 rotates clockwise by 90°, the right angle of the front locking piece 32 is positioned at the upper right, and the rear locking piece 33 is in a vertical state; in this case, the rear locking piece 33 alone limits the door plate 20, and the door plate 20 can only be opened outward. When the rotating shaft of the motor 31 rotates clockwise 180°, the right angle of the front locking piece 32 is positioned at the lower right, and the rear locking piece 33 is in a transverse state; in this case, the front locking piece 32 alone limits the door plate 20, and the door plate 20 can only be opened inward. When the rotating shaft of the motor 31 rotates clockwise by 270°, the right angle of the front locking piece 32 is positioned at the lower left, and the rear locking piece 33 is in a vertical state; in this case, the front locking piece 32 and the rear locking piece 33 simultaneously limit the door plate 20, and the door plate 20 is bidirectionally locked and cannot be opened. When the rotating shaft of the motor 31 rotates clockwise by 360°, the front locking piece 32 and the rear locking piece 33 returns to the initial positions.

Further, the distance from the axis of the rear locking piece 33 to any arc-shaped edge thereof is equal to the distance from the axis of the front locking piece 32 to any arc-shaped edge thereof, and the distance from the axis of the rear locking piece 33 to any straight edge thereof is equal to the distance from the axis of the front locking piece 32 to any right-angle edge thereof. The orthographic projections between the arc-shaped edge of the front locking piece 32 and the two arc-shaped edges of the rear locking piece 33 are positioned on the same circumference, an orthographic projection of one arc-shaped edge of the rear locking piece 33 exceeds another right-angled edge of the front locking piece 32, and an orthographic projection of another arc-shaped edge of the rear locking piece 33 coincides with the arc-shaped edge of the front locking piece 32. In this case, the front locking piece 32 and the rear locking piece 33 can be cut from two circular material pieces with the same diameter, so that the specification of the material pieces can be unified, the part processing cost is reduced, and the production efficiency is improved.

Further, a tab 21 protruding from a lower side of the door plate 20 is provided on the lower edge of the door plate 20, the tab 21 has a thinner thickness than that of the door plate 20, the front locking piece 32 is positioned on a front side of the tab 21, and the rear locking piece 33 is positioned on a rear side of the tab 21.

Further, a front side of the front locking piece 32 is provided with a manual knob 11 exposed out of the door frame 10. The manual knob 11 is configured to manually control the rotation of the door lock 30 to change a state of the door lock 30, thereby changing the door opening mode of the door plate 20.

Further, an identity identification module electrically connected to the circuit main board 34 is provided on the door frame 10, and the identity identification module is configured to verify an identity of a pet. The identity identification module sends the identity information of the pet to the circuit main board 34 after confirming the identity information of the pet, and the circuit main board 34 controls the motor 31 to change a state of the door lock 30. The door frame is provided with a sensing module 13 electrically connected to the circuit main board 34. The sensing module 13 wakes up the circuit main board 34 when sensing the approach of a pet. An identification distance of the identity identification module is 10-30 cm, and an identification distance of the sensing module 13 is 80-220 cm. That is, when the pet approaches, the sensing module 13 feeds back a signal to the circuit main board 34, and the circuit main board 34 is awakened. When the pet approaches further, the identity identification module verifies the identity of the pet and controls the motor 31 to change the state of the door lock 30. This arrangement can not only save power consumption of the power source 35 and bur also greatly reduce the delay of sensing.

Further, an outer sidewall of the door frame 10 is provided with a function button 12, a radio frequency antenna 14 is mounted in the door frame 10, and the function button 12 and the radio frequency antenna 14 are each electrically connected to the circuit main board 34. The radio frequency antenna 14 may be matched with a remote controller, and the user can remotely control the rotation of the motor 31 to select a corresponding door opening or door closing mode, making it more convenient to use. The user can also directly set the mode through the function button 12. It may be understood that the sensing module 13, the circuit main board 34, the radio frequency antenna 14, the identity identification module, and a remote terminal that can achieve the above control functions are all available in the market directly.

It is clear that the embodiments described above are only some but not all of the embodiments of the present application. The drawings show the preferred embodiments of the present application, but do not limit the patent scope of the present application. The present application may be implemented in many different forms. Rather, these embodiments are provided so that this disclosure of the present application will be understood thoroughly and completely. Although the present application has been described in detail with reference to the foregoing embodiments, for those skilled in the art, modifications may be still made to the technical solutions described in the foregoing specific embodiments, or equivalent substitutions may be made to some of technical features. The equivalent structural transformations made by using the contents of the specification and the drawings of the present application, or direct or indirect applications to other related technical fields, are all included in the patent protection scope of the present application.

What is claimed is:

1. A smart pet door, comprising: a door frame (10), a door plate (20) and a door lock (30), wherein the door plate (20) is hinged to an upper frame of the door frame (10), and the door lock (30) is mounted on a lower frame of the door frame (10);
the door lock (30) comprises a motor (31), a front locking piece (32), a rear locking piece (33), a circuit main board (34) and a power supply (35), wherein the front locking piece (32) and the rear locking piece (33) are coaxially arranged and are in transmission connection with the motor (31), the motor (31) is electrically connected to the circuit main board (34), and the circuit main board (34) is electrically connected to the power supply (35);
the front locking piece (32) is positioned on a front side of a lower edge of the door plate (20), the rear locking piece (33) is positioned on a rear side of the lower edge of the door plate (20), and the motor (31) drives the front locking piece (32) and the rear locking piece (33) to rotate, so that the door lock (30) is in one of following four states;
when the door lock (30) is in a first state, the front locking piece (32) and the rear locking piece (33) both block the door plate (20) from being rotated and opened;
when the door lock (30) is in a second state, the front locking piece (32) and the rear locking piece (33) both avoid the door plate (20), and the door plate (20) is able to be rotated and opened bidirectionally;
when the door lock (30) is in a third state, the front locking piece (32) blocks the door plate (20), the rear locking piece (33) avoids the door plate (20), and the door plate (20) is able to be opened inward only; and
when the door lock (30) is in a fourth state, the front locking piece (32) avoids the door plate (20), the rear locking piece (33) blocks the door plate (20), and the door plate (20) is able to be opened outward only.

2. The smart pet door according to claim 1, wherein the front locking piece (32) and the rear locking piece (33) are able to abut against the door plate (20) separately, or abut against the door plate (20) simultaneously, or disengage from the door plate (20) simultaneously.

3. The smart pet door according to claim 1, wherein the front locking piece (32) and the rear locking piece (33) are parallel to each other and are arranged at intervals on a rotating shaft of the motor (31), and a distance between the front locking piece (32) and the rear locking piece (33) is adapted to a thickness of the lower edge of the door plate (20).

4. The smart pet door according to claim 3, wherein the front locking piece (32) is in a right-angled sector shape, the rear locking piece (33) is in a waist-like shape, and one right-angled edge of the front locking piece (32) is parallel to two straight edges of the rear locking piece (33).

5. The smart pet door according to claim 4, wherein a distance from an axis of the front locking piece (32) to an arc-shaped edge thereof is greater than a height from the axis of the front locking piece (32) to the lower edge of the door plate (20), and a distance from the axis of the front locking piece (32) to any right-angle edge thereof is less than the height from the axis of the front locking piece (32) to the lower edge of the door plate (20).

6. The smart pet door according to claim 5, wherein a distance from an axis of the rear locking piece (33) to any arc-shaped edge thereof is greater than a height from the axis of the rear locking piece (33) to the lower edge of the door plate (20), and a distance from the axis of the rear locking piece (33) to any straight edge thereof is less than the height from the axis of the rear locking piece (33) to the lower edge of the door plate (20).

7. The smart pet door according to claim 6, wherein the distance from the axis of the rear locking piece (33) to any arc-shaped edge thereof is equal to the distance from the axis of the front locking piece (32) to any arc-shaped edge thereof, and the distance from the axis of the rear locking piece (33) to any straight edge thereof is equal to the distance from the axis of the front locking piece (32) to any right-angle edge thereof.

8. The smart pet door according to claim 3, wherein a tab (21) protruding from a lower side of the door plate (20) is provided on the lower edge of the door plate (20), the tab (21) has a thinner thickness than that of the door plate (20), the front locking piece (32) is positioned on a front side of the tab (21), and the rear locking piece (33) is positioned on a rear side of the tab (21).

9. The smart pet door according to claim 3, wherein the front locking piece (32) and the rear locking piece (33) are circumferentially and evenly divided into four regions, and wherein the door lock (30) is in the first state when a first region is aligned with the lower edge of the door plate (20), the door lock (30) is in the second state when a second region is aligned with the lower edge of the door plate (20), the door lock (30) is in the third state when a third region is aligned with the lower edge of the door plate (20), and the door lock (30) is in the fourth state when a fourth region is aligned with the lower edge of the door plate (20).

10. The smart pet door according to claim 1, wherein a front side of the front locking piece (32) is provided with a manual knob (11) exposed out of the door frame (10), and the manual knob (11) is configured to manually control the rotation of the door lock (30) to change a state of the door lock (30).

11. The smart pet door according to claim 1, wherein an identity identification module electrically connected to the circuit main board (34) is provided on the door frame (10), the identity identification module is configured to verify an identity of a pet and send the identity information of the pet to the circuit main board (34) after confirming the identity information of the pet, and the circuit main board (34) controls the motor (31) to change a state of the door lock (30).

12. The smart pet door according to claim 11, wherein the door frame (10) is provided with a sensing module (13) electrically connected to the circuit main board (34), and the sensing module (13) wakes up the circuit main board (34) when sensing the approach of a pet; and wherein an identification distance of the identity identification module is 10-30 cm, and an identification distance of the sensing module (13) is 80-220 cm.

13. The smart pet door according to claim 1, wherein the upper frame of the door frame (10) is provided with a battery compartment (15), and the power supply (35) is provided within the battery compartment (15).

14. The smart pet door according to claim 1, wherein a back side of the door frame (10) is provided with a mounting frame (16), and the mounting frame (16) is configured to clamp to a door opening.

15. The smart pet door according to claim 14, wherein one side of the mounting frame (16) far away from the door frame (10) is detachably assembled with a rear frame (17), an outer frame of the rear frame (17) is larger than that of the mounting frame (16), and after the door frame (10) and the mounting frame (16) are clamped to the door opening, and the rear frame (17) is assembled with the mounting frame (16) to secure the smart pet door.
